(19) United States
(12) Patent Application Publication
(10) Pub. No.: US 2006/0104292 A1
(43) Pub. Date: May 18, 2006

(54) System and methods for supporting multiple communications interfaces with single client interface

(76) Inventors: Vivek G. Gupta, Portland, OR (US); Tsung-Yuan C. Tai, Portland, OR (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/989,119

(22) Filed: Nov. 15, 2004

(51) Int. Cl. H04L 12/56; H04L 12/28

(52) U.S. Cl. 370/401

(57) ABSTRACT

Systems and methods for providing network connectivity to a host through multiple communication interfaces. Other embodiments include systems and methods for selecting on of a plurality of communication interfaces through which to perform network operations.

### TECHNICAL FIELD

Various embodiments described herein relate to network communications generally, including apparatus, systems and methods for improved wireless communications.

### BACKGROUND

More and more consumers are using wireless devices to remain connected to the world around them. Cell phone users can retrieve movie listings while traveling to the theater. Computer users can sit in a coffee shop and retrieve their email any time of the day. To support this ever-expanding use of network connectivity, multiple communications protocols are being implemented. Seamless connectivity between these multiple communications protocols are needed to ensure end-user ease of use.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a block diagram of networked devices according to embodiments of the present invention;

FIG. 2 is a high level block diagram of a device as depicted in FIG. 1, according to embodiments of the present invention;

FIG. 3A is a flowchart of a high level method to be used by a device as contemplated by FIG. 2 according to embodiments of the present invention;

FIG. 3B is a flowchart of a high level method to be used by a device as contemplated by FIG. 2 according to embodiments of the present invention;

FIG. 4 is a diagram of an example of dataflow in a system, such as the system depicted in FIG. 2, according to embodiments of the present invention; and

FIG. 5 is a high level block diagram of an architecture according to embodiments of the present invention.

### DETAILED DESCRIPTION

In the following detailed description of embodiments of the invention, reference is made to the accompanying drawings which form a part hereof, and in which is shown by way of illustration specific preferred embodiments in which the subject matter may be practiced. These embodiments are described in sufficient detail to enable those skilled in the art to practice them, and it is to be understood that other embodiments may be utilized and that logical, mechanical, and electrical changes may be made without departing from the spirit and scope of the present disclosure. Such embodiments of the inventive subject matter may be referred to, individually and/or collectively, herein by the term “invention” merely for convenience and without intending to voluntarily limit the scope of this application to any single invention or inventive concept if more than one is in fact disclosed. The following detailed description is, therefore, not to be taken in a limiting sense, and the scope of the present disclosure is defined only by the appended claims.

Reference is made in the detailed description to communications layers. It is to be understood that such layers refer to the layers of the Open System Interconnection (OSI) model.

The “physical layer” or layer 1 refers to any system for the transmission and reception of bits from one device to another which regulates the transmission over a physical medium, such as a wireless communications link.

The “data link layer” or layer 2 packages raw bits from the physical layer into logical, structured data packets.

The “network layer” or layer 3 determines the route from the source to the destination device and manages operations such as switching, routing and controlling packet congestion.

The “transport layer” or layer 4 allows for reliable end to end delivery of data and receives packets from and sends packets to the network layer as well as sending receipt acknowledgments.

The “session layer” or layer 5 establishes, maintains and ends sessions across the network. The session layer is responsible for name recognition (identification) so only the designated parties can participate in the session.

The “presentation layer” or layer 6 translates from application to network format and vice-versa. The presentation layer is responsible for protocol conversion, character conversion, data encryption/decryption, expanding graphics commands, data compression and provides seamless communication from multiple protocol stacks.

The “application layer” or layer 7 is used for applications specifically written to run over the network, and allows for access to network services that support applications. The application layer directly represents the services that directly support user applications.

Typically, information travels down the layer model, e.g. from the transport to the network, from the network to the data link, and from data link to the physical and is then transmitted over the medium to some device which receives at the “physical layer”, and then sends the information up the layer model to the data link, the network, and to the transport layers, in that order. It will be appreciated by those skilled in the art that some network implementations may neglect some of the layers of the OSI model or combine them in operation.

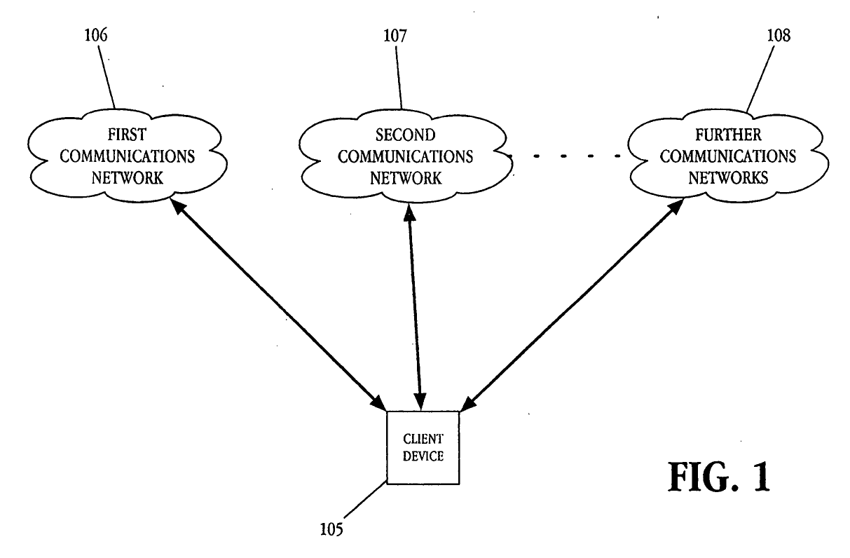

FIG. 1 is a high level block diagram of networked devices according to embodiments of the present invention. In an embodiment a client device 105 is able to access a plurality of communications networks 106, 107 and 108. In an embodiment, the client device 105 accesses the plurality of communications networks 106, 107 and 108 through some communications protocol and is configured to transmit data signals to the network and receive wireless data signals from the network. Data signals may include, without limitations, wireless data signals, network packet data, network signals, etc. Wireless data signals may include, without limitation: Global System for Mobile Communications (GSM); General Packet Radio Service (GPRS); Code Division Multiple Access (CDMA); Time Division Multiple Access (TDMA); IEEE 802.11 standard signals, IEEE std. 802.11-1999, published 1999 and later versions (hereinafter IEEE 802.11 standard); IEEE 802.16 standard signals, IEEE std. 802.16-2001, published 2001 and later versions (hereinafter IEEE 802.16 standard); IEEE 802.15 standard signals, IEEE std. 802.15.1-2003, published 2003, IEEE 802.15.2-2003, published 2003, IEEE 802.15.3-2003, published 2003 and later versions (hereinafter IEEE 802.15 standard); Wide Band CDMA (WCDMA); High Speed Downlink Packet Access (HSDPA); or Ultra WideBand (UWB). Though specific types of wireless signals are listed, for the embodiments herein it is to be appreciated that any signal that passes between two devices without a wire is considered to be a wireless signal. It will be appreciated by those skilled in the art that though mentions is made here to wireless signals, the systems and methods described herein apply equally to wired as well as wireless networks.

In an embodiment each of the plurality of communications networks 106, 107 and 108 are a network capable of providing connectivity between client devices 105 and some other interconnected network of devices, such as the internet, cellular phone network or private network. In an embodiment, each of the plurality of communications networks 106, 107 and 108 are configured to operate using differing communications protocol. In such an example, one communications network 106 may be using GSM/GPRS for communications, while a second communications network 107 is using 802.11 signals for communications. In an embodiment, the client device 105 is configured to communicate using any suitable communications protocol and is capable of operating on non-compatible communications networks simultaneously. In an embodiment, non-compatible communications networks are those networks where a device configured to operate on one network would be unable to operate on another network. For example, a device using GSM/GPRS for communications would be incompatible with a network using 802.11 for communications.

In an embodiment, the client device 105 provides a user the ability to connect to a suitable network, such as the internet or cellular phone network, through at least one of the plurality of communications networks 106, 107 and 108. In another embodiment, the client device 105 is a wireless client device. The wireless client device 105 may include, without limitation, a cellular telephone, a personal digital assistant (PDA), a laptop computer, a desktop computer, an internet appliance or any device capable of receiving and/or transmitting wireless data signals to another device. Though the transmission between the client device 105 and the plurality of communications networks 106, 107 and 108 is depicted as being bi-directional, it should be appreciated that the client device 105 may exclusively either just transmit signals to or receive signals from the access point 105, such that the communications between them are essentially uni-directional.

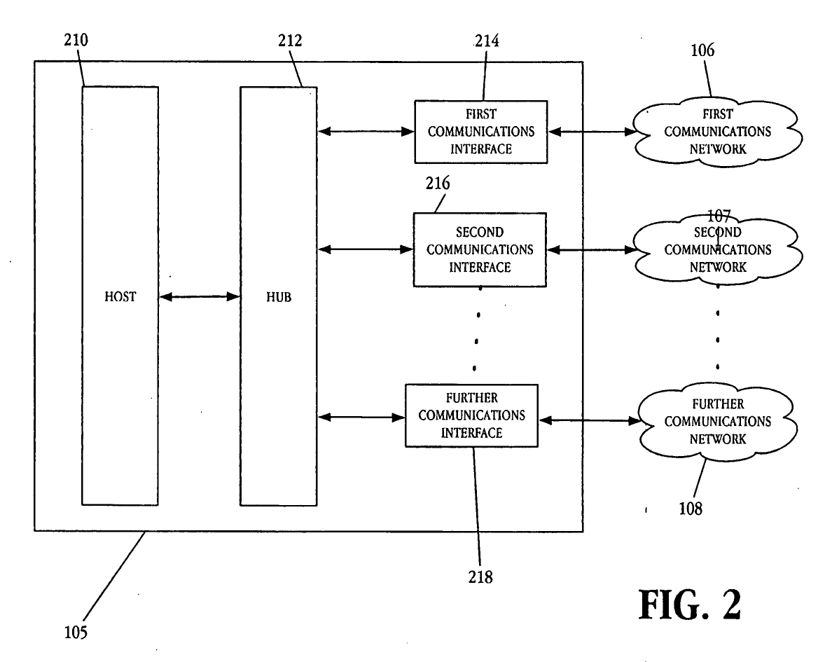

FIG. 2 is a high level block diagram of a device as depicted in FIG. 1, according to embodiments of the present invention. In an embodiment the device is a client device 105 as contemplated in FIG. 1. In a further embodiment, the client device 105 is a wireless client device. In an embodiment, the client device 105 comprises a host 210, a hub 212 and a plurality of communications interfaces 214, 216 and 218.

In an embodiment, the hub 212 couples the host 210 and the plurality of communications interfaces 106, 107 and 108. The use of the term hub is not intended to be limiting in any way. In the present description and the claims appended, the term hub is used to denote any device capable of receiving a network signal from a device and routing such signals to an appropriate destination. Routing may include, without limitation, re-addressing, re-directing, address translation, etc. In such an arrangement the device sending a signal to the hub directs all its network traffic to the hub without regard to devices that the hub may be coupled to. The term hub may include, without limitation, routers, address translators and any equivalents unknown at present.

The plurality of communications interfaces 106, 107 and 108 are configured to communicate with a plurality of communications networks 106, 107 and 108. Each of the plurality of communications networks 106, 107 and 108 operate using a different communications protocol. In another embodiment, each of the communications interfaces 214, 216 and 218 are configured to communicate with each of the communications networks 106, 107 and 108. In a further embodiment, each of the communications interfaces 214, 216 and 218 are configured to operate on at least one of the communications networks 106, 107 and 108. For example, a first communications network 106 may operate using GSM/GPRS compatible signals. In such an example, a first communications interface 214 would be configured to send and receive GSM/GPRS compatible signals. Further, a second communications network 107 may operate using 802.11 compatible signals and the second communications interface 216 would be configured to send and receive signals of that type. In an embodiment, the communications interfaces 214, 216 and 218 further comprises a communications driver and a communications radio. In another embodiment, the functions of a communications driver and a communications radio are combined in a single system element.

In an embodiment, the hub 212 is configured to receive communications from the host 210 and route such communications to at least one of the plurality of communications interfaces 214, 216 and 218. In another embodiment, the hub 212 may route such communications to all of the plurality of communications interfaces 214, 216 and 218. In a further embodiment, the hub 212 may route such communications to less then all of the plurality of communications interfaces 214, 216 and 218.

In an embodiment, the host 210 is at least configured to run user applications and an operating system, as well as sending network communications from the user applications and operating system and receiving network communications addressed to the user applications and operating systems. In such an example all network communications from the user applications and operating system are addressed to the hub 212 and all communications addressed to the user applications and operating system are from the hub 212. In an embodiment, the host 210 is configured to communicate with the hub 212 at layer 3 and higher of the OSI model. In another embodiment, the host 210 is configured to communicate with the hub 212 at a layer higher then layer 2 of the OSI model.

In an embodiment, the hub 212 is configured to appear as a single network interface to the host 210. In such an arrangement, the host 210 performs no communications directly with the plurality of communications interfaces 214, 216 and 218. Further, such an arrangement only requires that the host 210 requires a single communications driver for communications between itself and the hub 212. In an embodiment, the hub 212 communicates with the plurality of communications interfaces 214, 216 and 218 at layer 2 of the OSI model. In another embodiment, the hub 212 communicates with the plurality of communications interfaces 214, 216 and 218 at a layer higher then layer 1 and lower then layer 3 of the OSI model. In yet another embodiment, the hub 212 communicates with the plurality of communications interfaces 214, 216 and 218 at a layer other then the physical layer.

In one embodiment, the connection, or interconnect, between the hub 212 and the host 210 is physical through an input/output (I/O) bus. Examples of an I/O bus include, without limitation, Peripheral Component Interconnect (PCI), PCI Express, Universal Serial Bus (USB), Mobile Scalable Link (MSL) and the like. In another embodiment, the connection, or interconnect, is logical. In a further embodiment, the logical interconnect may be on a single machine.

In one embodiment of the client device 105 the communications radio of the communications interface is operably coupled to an antenna. In such an example, the antenna is configured to receive wireless signals and pass those signals to the communications radio. The antenna may include one or more of a patch, omni-directional, beam, monopole, dipole, and rhombic antenna, among others.

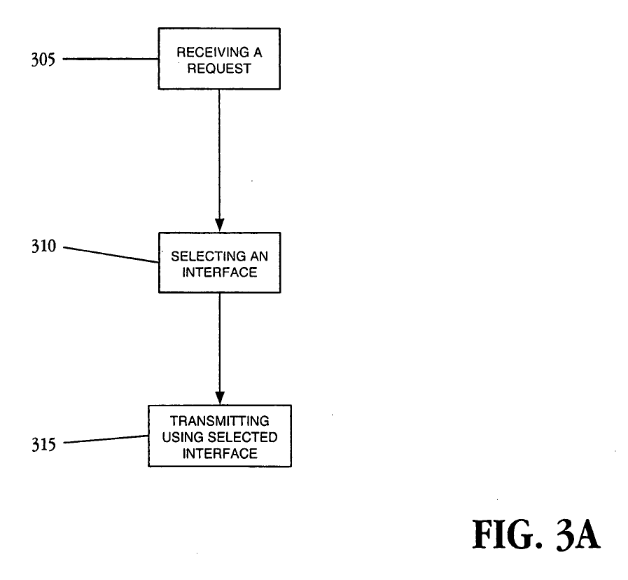

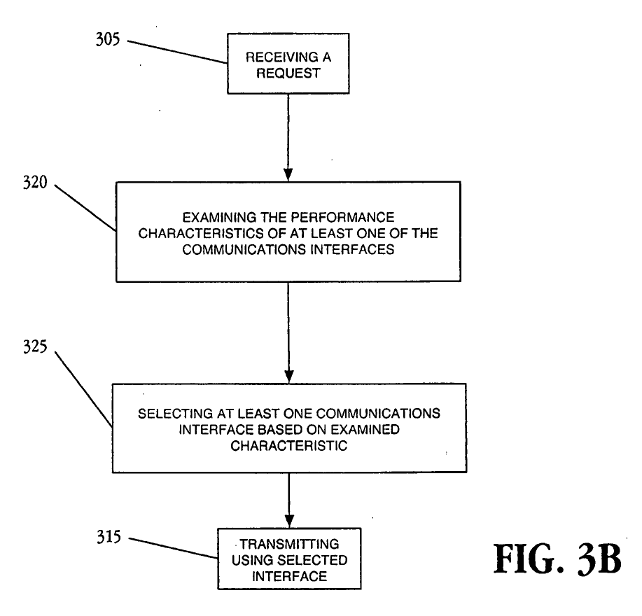

FIG. 3A is a flowchart of a high level method to be used by a device as contemplated by FIG. 2 according to embodiments of the present invention. At block 305 a request is received by a hub 212. In an embodiment, the request is a request for the transmission of network signals from a host 210. In such an example, the request is addressed to the hub 212 and not to any communications interface. At block 310, the hub 212 selects at least one of the plurality of communications interfaces 214, 216 and 218 over which to send the transmission. At block 315 the hub 212 transmits the network signals from the host 210 to the communications network that the selected communications interface is configured to communicate with. Further network communications required by the user applications and operating systems can utilize the selected user interface for those communications. In an alternate embodiment, the hub 212 selects at least one of a plurality of communications interfaces 214, 216 and 218 when communications are first setup with the host 210, such as at the start-up of the client device.

FIG. 3B is a flowchart of a high level method to be used by a device as contemplated by FIG. 2 according to embodiments of the present invention. FIG. 3B is similar to FIG. 3A with the addition of block 320 and block 325 for selection of a communications interface.

In an embodiment, at block 320 the hub 212 examines the performance characteristics of at least one of a plurality of communications interfaces 214, 216 and 218. Performance characteristics include, without limitation: number of other client devices operating on the communications network accessible to the communications interface that are physically proximate to the present client device; the signal to noise ratio (SINR) of the communications network accessible to the communications interface; the speed of data transmission, or throughput between the communications interface and the communications network accessible to the communications interface; the reliability of the connection between the communications interface and the communications network accessible to the communications interface; the Quality of Service (QOS) of data transmitting between the communications interface and the communications network accessible to the communications interface; the signal strength received by the communications interface; the distance from the client device to a receiver station operating on the communications network accessible to the communications interface; the usage of the communications interface by the hub 212 or other devices in the client device, where usage can be defined as which of the plurality of communications interfaces is or is not performing operations; the amount of system resources, such as power, being used by the communications interface; and the number of receivers able operating on the communications network accessible to the communications interface that are able to communicate with the communications interface.

In a further embodiment, another aspect of performance characteristics may be the economic cost of operation on that communications network. Economic cost may be expressed as the price charged by the provider of that communications network to the user of the client device. For example, on a GSM/GPRS network, devices may be charged on a per-minute basis for all communications. Similarly, another communications network, such as an 802.16 network, may charge the device by the number or size of data being communicated. In such an example, the economic cost to transmit through that interface may be a performance characteristic to use.

At block 325 the hub 212 selects at least one of the plurality of communications interfaces 214, 216 and 218. In an embodiment, the selection made at block 325 of at least one of the plurality of communications interfaces 214, 216 and 218 is based on the interface that has the optimal performance characteristics. It will be appreciated that in some instances the performance characteristic being used will favor an interface with lower performance, such as the performance characteristic of users physically proximate to the interface. In such an example, it would be advantageous for the number of users to be small as such a situation would indicate that higher performance is possible.

In a further embodiment, the examining of performance characteristics at block 320 and the selection of at least one interface at block 325 is continuous. This may include, without limitation, occurring prior to the transmission of any network signal, or occurring periodically to determine the interface over which to operate. In such an example the hub 212 can continuously monitor the present and future economic costs of communications as discussed above and continuously choosing the communications network that is the least costly. Continuous monitoring of performance characteristics allow for easy mobility for users which can affect availability of communications networks. In an embodiment, continuous monitoring and selection of a communications interface by the hub has no effect on the connection between the host and the hub. That connection undergoes no change when the communications interface selected by the hub is changed. Additionally, addition of further communications interfaces coupled to the hub can be accomplished with no change to the configuration of the host.

In an embodiment, selection of an interface occurs when the connection between the host 210 and the hub 212 is first made, such as at system start. In such an example, the host 210 may specify connection parameters when first setting up the connection. In this example, the hub 212 may further switch connections from one communications interface to another dynamically based on changing conditions described above. Such switching of connections would be transparent to the host 210, i.e. without any reconfiguration of the host's 210 communication set-up. In such an example, the host 210 maintains communications with the hub 212, while the hub 212 switches connections between communication interfaces 214, 216 and 218. The hub 212 is able to continuously adapt the network link based on changes in environment, or performance characteristics. This provides a benefit to the host in that the host gets the best performance from the communications networks at any instant, without any software application or other component undergoing any change.

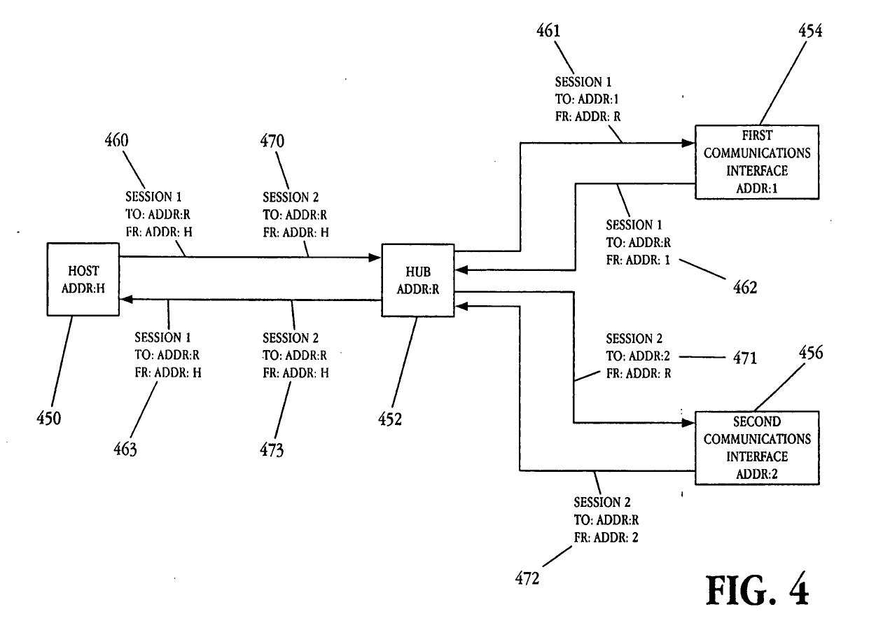

FIG. 4 is a diagram of an example of dataflow in a system, such as the system depicted in FIG. 2, according to embodiments of the present invention. This example is merely illustrative of one aspect of dataflow possible with the previously discussed embodiments of the invention and is not meant to be limiting in any way. In FIG. 4, there is a host 450, such as the host 210 depicted in FIG. 2; a hub 452, such as the hub 212 depicted in FIG. 2; and two communications interfaces 454 456, such as the communication interfaces 214, 216 and 218 depicted in FIG. 2. In this example the host 450 conducts two separate communications sessions, Session 1 and Session 2. In an embodiment, the host 450 has a network address of H, the hub 452 has a network address of R, communications interface #1 454 has a network address of 1 and communications interface #2 456 has a network address of 2. It will be appreciated that these do not represent true network addresses but are being used to illustrate an example dataflow according to embodiments of the present invention and the discussion following in regards to address headers has been simplified as well.

In an embodiment, a first communication session is begun and signals are sent from the host 450 to the hub 452. As discussed above all network communications from the host 450 are addressed directly to the hub 452. A transmission block 460 is sent from the host 450 to the hub 452, with the address header containing ADDR:R as the to-addressee and ADDR: H as the from-addressee. This transmission is received by the hub 452, which selects a communications interface according to embodiments discussed above. In one embodiment, the hub 452 has selected a communications interface when communications are first established. In a further embodiment, the hub 452 functions as a layer 2 device.

In this example, communications interface #1 454 is used for session #1. The transmission block 460 is re-addressed as a new transmission block 461 with the address header containing ADDR: 1 as the to-addressee and ADDR: H as the from-addresses. The information contained in new transmission block 460 is substantially similar to the first transmission block 460 with the exception of the address header. The signal in response to the transmission is received by communications interface #1 454 and sent as a return transmission block 462 with the address header containing ADDR: R as the to-addressee and ADDR: 1 as the from-addressee. This is transmitted to the hub 452 which re-addresses the transmission as a new transmission block 463 with the address header containing ADDR: H as the to-addressee and ADDR: R as the from-addressee. In an embodiment, all communications between host 450 and hub 452 are conducted at layer 3 and higher of the OSI model; while all communications between the hub 452 and the communications interfaces 454 456 are conducted at a layer lower then layer 3 of the OSI model.

FIG. 4 further depicts a second session of communications. As with the previous example, the transmission block 470 sent from the host 450 to the hub 452 has an address header containing ADDR: R as the to-addressee and ADDR: H as the from-addressee. After selecting communications interface # 2 456 the hub 452 re-addresses the transmission block 470 and sends a new transmission block 471 with an address header containing ADDR: 2 as the to-addressee and ADDR: R as the from-addressee to communications interface #2 456. Following receipt of some signal in response to the original transmission block 470, communications interface sends a return transmission block 472 with the address header containing ADDR: R as the to-addressee and ADDR: 2 as the from-addressee. The hub 452 re-addressed the return transmission block 472 as a new transmission block 473 with the address header containing ADDR: H as the to-addressee and ADDR: R as the from-addressee.

Though described here as distinct sessions, it will be appreciated that a session may contain multiple numbers of transmission requests and replies. In such an arrangement, each segment of the transmission may be handled by a differing communications interface as discussed above with respect to FIG. 3B. Additionally, the portions of the transmission that are being sent may be handled by different interfaces then those portions that are being received.

In an embodiment, the address mappings described above happen only during times of mobility of the client device, i.e. moving from one location or network to another. This may also be called a change of network attachment point. During such a change of network attachment points, the host remains unaware of the change and the hub 452 switches the connection to the communications interface dynamically. In another embodiment, the address mapping described above happens continuously such that selection of communications interfaces for the transmission of individual signals occurs. In yet another embodiment, the address mapping described above occurs periodically as the hub 212 optimizes network connectivity.

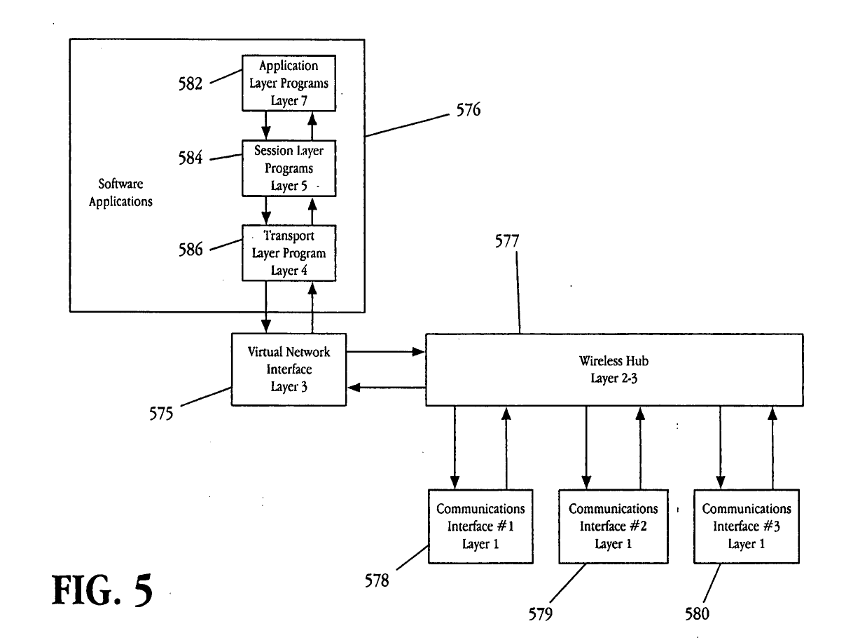

FIG. 5 is a high level block diagram of an architecture according to embodiments of the present invention. In an embodiment, the virtual network interface 575 is configured to receive network communications from software applications 576. In an embodiment, software applications 576 include an operating system. In another embodiment, the virtual network interface 575 is a software module within an operating system. In a further embodiment, the virtual network interface 575 operates at layer 3 of the OSI model. The virtual network interface 575 is coupled to a wireless hub 577 through a hardware interconnect. The wireless hub 577 is further coupled to a plurality of communications interfaces 578, 579 and 580. In an embodiment, the wireless hub and attached communication interfaces can also be a chip or Application Specific Integrated Chip (ASIC) and may be attached to host system through any suitable coupling as is well known in the art.

In an embodiment the virtual network interface 575 receives network communications from software applications 576 communicating at network layers higher than layer 3. In an embodiment the virtual network interface 575 appears as a layer 3 network device to applications performing operations at layer 4 and higher. Such applications may include without limitation, a web browser communicating HyperText Transfer Protocol (HTTP) requests at layer 7 582, the operating system requesting an IP address via the Dynamic Host Control Protocol (DHCP) at layer 5 584 or User Datagram Protocol (UDP) requests at layer 4 586. For example, a user using a web browser requests a web page. The web browser issues an HTTP request, which is at layer 7 of the OSI. The request is sent to the virtual network interface 575 which operates at layer 3. The virtual network interface sends the request to the wireless hub 577, which operates a layer lower than layer 3 of the OSI model. In an embodiment, further operations of the wireless hub are as described above with respect to FIG. 3A and FIG. 3B.

In an embodiment, the wireless hub 577 appears to the virtual network interface 575 as a single wireless radio. In such an arrangement the virtual network interface 575 need only be configured with communications drivers for the wireless hub 577. It need not have drivers for the plurality of communications interfaces 578, 579 and 580, which the wireless hub 577 is coupled to. In a further embodiment, the virtual network interface 575 may be coupled to additional communication interfaces, such as a wireline communications interface.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This detailed description, therefore, is not to be taken in a limiting sense, and the scope of various embodiments is defined only by the appended claims, along with the full range of equivalents to which such claims are entitled.

Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments of the invention. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

What is claimed is:

1. Apparatus, comprising:
a host;
a plurality of communication interfaces, at least one of which comprises:
a wireless communications driver; and
a wireless communications radio; and
a hub to couple the plurality of communication interfaces to the host, separately coupled to the host and the plurality of communication interfaces.

2. The apparatus of claim 1, wherein the hub is to route communication requests from the host to one of the plurality of wireless communication interfaces.

3. The apparatus of claim 2, wherein the communication requests are addressed to the hub.

4. The apparatus of claim 3, wherein the hub is to re-address the communication request.

5. The apparatus of claim 1, wherein at least one of the communication interfaces is to operate in compliance with the IEEE 802.11 standard.

6. The apparatus of claim 1, wherein at least one of the communication interfaces is to operate in compliance with the IEEE 802.16 standard.

7. The apparatus of claim 1, wherein at least one of the communication interfaces is to operate in compliance with the GSM/GPRS standard.

8. The apparatus of claim 1, wherein at least one of the communication interfaces is to transmit and receive Wide Band CDMA (WCDMA).

9. The apparatus of claim 1, wherein at least one of the communication interfaces is to operate in compliance with the Ultra-Wide Band (UWB) standard.

10. The apparatus of claim 1, wherein at least one of the communication interfaces is to operate using any suitable communications protocol.

11. The apparatus of claim 1, wherein the hub is to select a suitable communications protocol.

12. A method, comprising:
receiving a request for the transmission of data items to a network, wherein the request has a destination address that relates to a hub;
selecting one of a plurality of communication interfaces; and
transmitting the data items and further data items using the selected communication interface.

13. The method of claim 12, wherein selecting further comprises:
determining at least one communication interface with an optimal performance characteristic; and
selecting the determined optimal communication interface.

14. The method of claim 13, wherein the performance characteristic is the usage of system resources.

15. The method of claim 13, wherein performance characteristic is signal strength.

16. The method of claim 13, wherein the performance characteristic is the usage of the communications interface.

17. A machine readable medium having machine executable instructions contained therein, which when executed perform the following operations:
receiving a request for the transmission of data items to a network, wherein the request has a destination address that relates to a hub;
selecting one of a plurality of communication interfaces; and
transmitting the data items and further data items using the selected communication interface.

18. The machine readable medium of claim 17, wherein the communication interface is a wireless communication interface.

19. The machine readable medium of claim 17, wherein transmitting the data items and further data items occurs at a layer lower then layer 3 of the OSI model.

20. The machine readable medium of claim 17, wherein the request for the transmission of data items occurs at layer 3 or higher of the OSI model.

21. A method, comprising:
receiving a request for the transmission of data items to a network, wherein the request has a destination address that relates to a hub;
examining the economic cost of transmitting the data items through a plurality of communications interfaces capable of transmitting data items to a network through at least one of a plurality of communications networks;
selecting the communications interface based on the examined economic cost; and
transmitting the data items using the selected communications interface.

22. The method of claim 21, further comprising:
transmitting further data items using the selected communications interface.

23. The method of claim 21, wherein selecting includes selected the communications interface with the lowest present economic cost.

24. The method of claim 21, wherein selecting includes selecting the communications interface with the lowest future economic cost.

25. A machine readable medium having machine executable instructions contained therein, which when executed perform the following operations:
receiving a request for the transmission of data items to a network, wherein the request has a destination address that relates to a hub;
examining the economic cost of transmitting the data items through a plurality of communications interfaces capable of transmitting data items to a network through at least one of a plurality of communications networks;
selecting the communications interface based on the examined economic cost; and
transmitting the data items and further data items using the selected communications interface.

26. The machine readable medium of claim 25, wherein the communication interface is a wireless communication interface.

27. The machine readable medium of claim 25, wherein transmitting the data items and further data items occurs at a layer lower then layer 3 of the OSI model.

28. The machine readable medium of claim 25, wherein the request for the transmission of data items occurs at layer 3 or higher of the OSI model.

29. A system, comprising:
a host;
a plurality of communication interfaces, at least one of which comprises:
a communications driver; and
a communications radio;
a hub to couple the plurality of communication interfaces to the host, separately coupled to the host and the plurality of communication interfaces; and
an input device coupled to the host.

30. The system of claim 39, wherein the hub is to route communication requests from the host to one of the plurality of wireless communication interfaces.

31. The system of claim 30, wherein the communication requests are addressed to the hub.

32. The system of claim 31, wherein the hub is to re-address the communication request.

33. A system, comprising:
a plurality of communications interfaces, at least one of which comprises:
a communications driver; and
a communications radio;
a hub to couple the plurality of communication interfaces to the host, separately coupled to the host and the plurality of communications interfaces; and
at least one omni-directional antenna operably coupled to the at least one communications radio, wherein the omni-directional antenna is to receive a wireless signal.

34. The system of claim 33, wherein the hub is to route communication requests from the host to one of the plurality of wireless communication interfaces.

35. The system of claim 33, wherein the communication requests are addressed to the hub.

36. The system of claim 33, wherein the hub is to re-address the communication request.

37. Apparatus comprising:
a wireless hub coupled to a plurality of wireless communication interfaces; and
a virtual network interface coupled to the wireless hub to receive network communications from higher network layers and to send network communications to the wireless hub.

38. The apparatus of claim 37, wherein the virtual network interface is coupled to the wireless hub through a hardware interconnect.

39. The apparatus of claim 37, wherein the virtual network interface operates at layer 3.

40. The apparatus of claim 37, wherein the wireless hub operates at a layer lower then layer 3.

41. The apparatus of claim 37, wherein at least one of the plurality of wireless communication interfaces is to send and receive data signals from a wireless communications network.
